(19) United States
(12) Patent Application Publication
(10) Pub. No.: US 2026/0198482 A1
(43) Pub. Date: Jul. 16, 2026

(54) PERFUSATE COMPOSITIONS, METHODS, AND SYSTEMS

(71) Applicants: The Cleveland Clinic foundation, Cleveland, OH (US); Case Western Reserve University, Cleveland, OH (US)

(72) Inventors: Bahar Bassiri GHARB, Cleveland, OH (US); Srinivasan DASARATHY, Cleveland, OH (US); Henri BRUNENGRABER, Cleveland, OH (US)

(21) Appl. No.: 19/134,377

(22) PCT Filed: Nov. 28, 2023
(86) PCT No.: PCT/US2023/081241

§ 371 Date: May 30, 2025

Related U.S. Application Data
(60) Provisional application No. 63/385,725, filed on Dec. 1, 2022.

(51) Int. Cl. A01N 1/126; A01N 1/143; A01N 1/162

(52) U.S. Cl. CPC A01N 1/126; A01N 1/143; A01N 1/162

(57) ABSTRACT

Provided herein are perfusate compositions, and methods and systems for using such composition to perfuse a vascularized composite tissue (e.g., limb, face, abdominal wall or flap) to preserve such composite tissues (e.g., for auto or allotransplant). In certain embodiments, the perfusate compositions comprise at least one of the following reagents: i) N-acetylcysteine; ii) pantothenate or pantothenic acid at a concentration of at least 15 micromol/liter in said composition; and/or iii) carnitine, as well as further comprising one of the following: i) at least one bicarbonate/CO₂-dependent anaplerotic substrate, and at least one bicarbonate/CO₂ buffer, or ii) at least one non-bicarbonate/CO₂-dependent anaplerotic substrate. In certain embodiments, the perfusate compositions are free, or detectably free, of alpha amino acids.

The present application claims priority to U.S. Provisional application Ser. No. 63/385,725, filed Dec. 1, 2022, which is herein incorporated by reference in its entirety.

### FIELD

Provided herein are perfusate compositions, and methods and systems for using such composition to perfuse a vascularized composite tissue (e.g., limb, face, abdominal wall, or flap) to preserve such composite tissues (e.g., for auto or allotransplant). In certain embodiments, the perfusate compositions comprise at least one of the following reagents: i) N-acetylcysteine; ii) pantothenate or pantothenic acid at a concentration of at least 15 micromol/liter in said composition; and/or iii) carnitine, as well as further comprising one of the following: i) at least one bicarbonate/CO₂-dependent anaplerotic substrate, and at least one bicarbonate/CO₂ buffer, or ii) at least one non-bicarbonate/CO2-dependent anaplerotic substrate. In certain embodiments, the perfusate compositions are free, or detectably free, of alpha amino acids.

### BACKGROUND

Traumatic limb loss as a result of industrial injuries, motor vehicle accidents and military conflicts is expected to affect over 1.3 million people in USA by 2050. It is estimated that two thirds of these people are adolescents or young adults, necessitating years of prosthetic related health care expenses. A major limitation to successful replantation and transplantation of extremities is the lack of an adequate technology capable of preserving tissue viability for an extended period of time. Irreversible damage begins after 3 hours of warm ischemia, with complete skeletal muscle necrosis occurring in as soon as 6 hours. Currently, the only clinically available preservation technique for limbs is static cold storage, which can preserve major extremity segments for up to 12 hours. Static cold storage, the standard preservation method, slows the metabolic rate of the tissues. However, the cellular metabolic activities are not halted and anaerobic metabolism continues with subsequent depletion of energy stores, loss of transcellular electrolyte gradients, cell swelling, and lysis. Furthermore, accumulation of metabolic products during the ischemic period contributes to the production of toxic molecules following reperfusion, promoting ischemia, and reperfusion injury (IRI).

Ex vivo normothermic perfusion (EVNP) is a preservation technology that allows preservation of vascularized composite tissue in near physiologic conditions, by perfusion of a blood like oxygenated perfusate. The potential benefits of this technology have been proven in preclinical settings, and clinical trials are currently ongoing for liver, heart, lung and kidney transplants. EVNP can extend the duration of the time the vascularized composite tissue (e.g., limb) can be preserved following amputation, can contribute to improved viability of the vascularized composite tissue reversing the injury sustained during the organ procurement, and also determine the suitability to transplantation. However, (i) the ischemia initiated by procurement of the vascularized composite tissue, (ii) the multifaceted reperfusion injury induced by the restoration of blood and oxygen supply during EVNP, and (iii) the incomplete and inefficient intervention strategies to treat re-perfusion injury and restore metabolic integrity to the perfused vascularized composite tissue can affect the duration of preservation.

Although perfusion and oxygenation are easily provided to the vascularized composite tissue during EVNP, the metabolic integrity of an isolated perfused vascularized composite tissue is difficult to maintain after procurement. One particular difficulty is the disposal by muscle tissue of lactate and pyruvate generated by glycolysis in muscle. The oxidation of these compounds requires conversion of pyruvate+CO₂ to oxaloacetate via anaplerotic pyruvate carboxylase. In the absence of bicarbonate/CO₂ in the perfusate, carboxylation of pyruvate cannot take place.

### SUMMARY

Provided herein are perfusate compositions, and methods and systems for using such composition to perfuse a vascularized composite tissue (e.g., limb, face, abdominal wall, or flap) to preserve such composite tissues (e.g., for auto or allotransplant). In certain embodiments, the perfusate compositions comprise at least one of the following reagents: i) N-acetylcysteine; ii) pantothenate or pantothenic acid at a concentration of at least 15 micromol/liter in said composition; and/or iii) carnitine, as well as further comprising one of the following: i) at least one bicarbonate/CO₂-dependent anaplerotic substrate, and at least one bicarbonate/CO₂ buffer, or ii) at least one non-bicarbonate/CO₂-dependent anaplerotic substrate. In certain embodiments, the perfusate compositions are free, or detectably free, of alpha amino acids.

In some embodiments, provided herein are perfusate compositions (e.g., vascularized composite tissue perfusate compositions) comprising: a) at least one of the following: i) at least one bicarbonate/CO₂-dependent anaplerotic substrate, and at least one bicarbonate/CO₂ buffer, or ii) at least one non-bicarbonate/CO₂-dependent anaplerotic substrate; and wherein the composition is free or detectably free of alpha amino acids, and/or further comprises at least one of the following reagents: i) N-acetylcysteine; ii) pantothenate or pantothenic acid at a concentration of at least 15 micromol/liter in the composition; and/or iii) carnitine.

In certain embodiments, the composition is free or detectably free of alpha amino acids. In other embodiments, the composition comprises N-acetylcysteine. In further embodiments, the N-acetylcysteine is present in the composition at a concentration of at least 50 micromol/liter (e.g., at least 50 . . . 100 . . . 150 . . . 200 or 250 uM/L), or at a concentration between 50 and 200 micromol/liter (e.g., 50 . . . 70 . . . 90 . . . 120 . . . 180 . . . or 200 uM/L).

In some embodiments, the composition comprises pantothenate or pantothenic acid at a concentration of at least 15 micromol/liter in the composition (e.g., at least 15 . . . 25 . . . 50 . . . 100 uM/L or more). In certain embodiments, the pantothenate or pantothenic acid is present in the composition at a concentration between 15 and 50 micromol/liter.

In particular embodiments, the composition comprises carnitine. In other embodiments, the carnitine is present in the composition at a concentration of at least 50 micromol/liter (e.g., at least 50 . . . 150 . . . 200 . . . or 250 uM/L), or at a concentration between 50 and 200 micromol/liter.

In some embodiments, the at least one bicarbonate/CO₂-dependent anaplerotic substrate is selected from the group consisting of: pyruvate, lactate, heptanoate, precursors of propionyl-CoA (such as propionate or other odd-chain monocarboxylic fatty acids with at least 3 carbons or their salts or esters). In other embodiments, the at least one non-bicarbonate/CO₂-dependent anaplerotic substrate is selected from the group consisting of: even-chain dicarboxylic acids, or their salts or esters, of at least 6 carbons length which are converted in tissues to succinyl-CoA (e.g., including dodecanedioate).

In certain embodiments, the compositions further comprise a blood substitute or packed red blood cells. In additional embodiments, the blood substitute comprises a hemoglobin-based oxygen carrier (HBOC), such as Hemopure (hemoglobin glutamer-250(bovine); HBOC-201), or a stabilized form of hemoglobin. In additional embodiments, the at least one bicarbonate/CO₂ buffer comprises at least one of the following: sodium bicarbonate, magnesium sulphate, potassium phosphate, and NaCl+CaCl₂+KCl+glucose. In additional embodiments, the compositions further comprise at least one (e.g. or all) of the following: human albumin, insulin, glycerol, glucose, or methylprednisolone. In particular embodiments, the methods further comprise an antibiotic. In certain embodiments, the antibiotic is selected from the group consisting of: vancomycin, cefazolin, and ceftazidime.

In certain embodiments, provided herein are systems (e.g., ex vivo normothermic perfusion (EVNP) systems) for maintaining an isolated vascularized composite tissue in a near normal metabolic state comprising: A) a perfusion subsystem comprising one or more perfusion fluid paths for circulating a perfusate composition; and B) the perfusate composition, wherein the perfusate composition comprises: a) at least one of the following: i) at least one bicarbonate/CO₂-dependent anaplerotic substrate, and at least one bicarbonate/CO₂ buffer, or ii) at least one non-bicarbonate/CO₂-dependent anaplerotic substrate; and wherein the composition is free or detectably free of alpha amino acids, and/or further comprises at least one of the following reagents: i) N-acetylcysteine; ii) pantothenate or pantothenic acid at a concentration of at least 15 micromol/liter in the composition; and/or iii) carnitine.

In particular embodiments, the system further comprises: c) a vascularized composite tissue chamber configured for holding an isolated vascularized composite tissue, and wherein the perfusion subsystem is operably linked to the vascularized composite tissue chamber so as to perfuse a vascularized composite tissue when located in the vascularized composite tissue chamber.

In certain embodiments, the vascularized composite tissue (e.g., for perfusion in the system) is selected from a limb, face, abdominal wall or flap (e.g., where a flap is a piece of tissue that is disconnected from its'original blood supply, and is to be moved a distance to be reconnected to a new blood supply in the patient or another party). In some embodiments, the limb is at least part of an arm or at least part of a leg. In particular embodiments, the vascularized composite tissue comprises at least two (or three or four or all) of the following: skin, muscle, tendon, nerve, arteries, veins, and bone.

In some embodiments, the systems further comprise: c) an oxygen and carbon dioxide humidifier operably linked to the perfusion subsystem. In further embodiments, the systems further comprise: c) a temperature controller for maintaining temperature of the perfusate composition at about 25-37 degrees Celsius. In other embodiments, the systems further comprise: c) a monitoring subsystem for monitoring parameters of the perfusate composition. In additional embodiments, the systems further comprise: c) a tissue oxygen saturation and/or pressure monitoring subsystem. In particular embodiments, the systems further comprise: c) a pH monitoring and/or correcting subsystem operably linked to the perfusion subsystem. In other embodiments, the systems further comprise: c) an oxygenator operably linked to the perfusion subsystem.

In some embodiments, provided herein are methods for preserving an isolated vascularized composite tissue comprising: placing an isolated vascularized composite tissue into a container, wherein the container has located within a perfusate composition comprising: a) at least one of the following: i) at least one bicarbonate/CO₂-dependent anaplerotic substrate, and at least one bicarbonate/CO₂ buffer, or ii) at least one non-bicarbonate/CO₂-dependent anaplerotic substrate; and wherein the composition is free or detectably free of alpha amino acids, and/or further comprises at least one of the following reagents: i) N-acetylcysteine; ii) pantothenate or pantothenic acid at a concentration of at least 15 micromol/liter in the composition; and/or iii) carnitine.

In further embodiments, the container comprises a vascularized composite tissue chamber. In additional embodiments, the vascularized composite tissue chamber is operably linked to a perfusion subsystem that perfuses the vascularized composite tissue with the perfusate composition, wherein the perfusion subsystem comprises one or more perfusion fluid paths for circulating the perfusate composition.

In particular embodiments, the perfusion subsystem is operably linked to a substrate infusion subsystem. In additional embodiments, the substrate infusion subsystem comprises a substrate source comprising at least one, or all of, the following: N-acetylcysteine, pantothenate, beta-alanine, choline, and carnitine.

### DESCRIPTION OF THE FIGURE

FIG. 1 shows the exemplary perfusion system described in Example 1. This exemplary perfusion system includes at the least the following components: i) a vascularized composite tissue (VCT) chamber, ii) a weight scale; iii) fluid paths for circulating a perfusate composition (e.g., connected to: a) IV pumps (configured for perfusate exchange), b) a roller pump, c) a sampling manifold; and d) pressure monitor); iv) a temperature monitor (configured to monitor the temperature of the vascularized composite tissue in the vascularized composite tissue chamber); v) a tissue oxygen saturation monitor (configured to monitor the oxygen saturation of the vascularized composite tissue); vi) a pressure monitor; vii) a substrate infusion sub-system; viii) a sodium bicarbonate (NaHCO₃) infusion sub-system; ix) a carbon dioxide and oxygen humidifier; x) an oxygenator; xi) a pH monitor; xii) an oxygen and nitrogen gas infusion sub-system; xiii) reservoir A connected to: the pH monitor, the sodium bicarbonate infusion sub-system, and the substrate infusion sub-system, where reservoir A is, for example, configured for holding the main volume of the perfusate (as described herein), so as to perfuse the vascularized composite tissue over time; xiv) reservoir B, which is, for example, is configured to replace perfusate in reservoir A lost during the perfusate exchange process, which can start at, for example about 2 hours; and xv) reservoir C, which is, for example, configured to collect the perfusate removed from reservoir A in the perfusate exchange process that can start at, for example, 2 hours. The systems disclosed here may have one or more of the components depicted in FIG. 1 (e.g., 1 . . . 5 . . . 10 . . . or all of the components depicted in FIG. 1). Other suitable perfusion systems are known in the art, for example, as disclosed in U.S. Pat. Pubs. 20040038193 and 2021/0289771 (both of which are herein incorporated by reference, particularly for perfusion systems disclosed therein), and can be used with the perfusate compositions described herein.

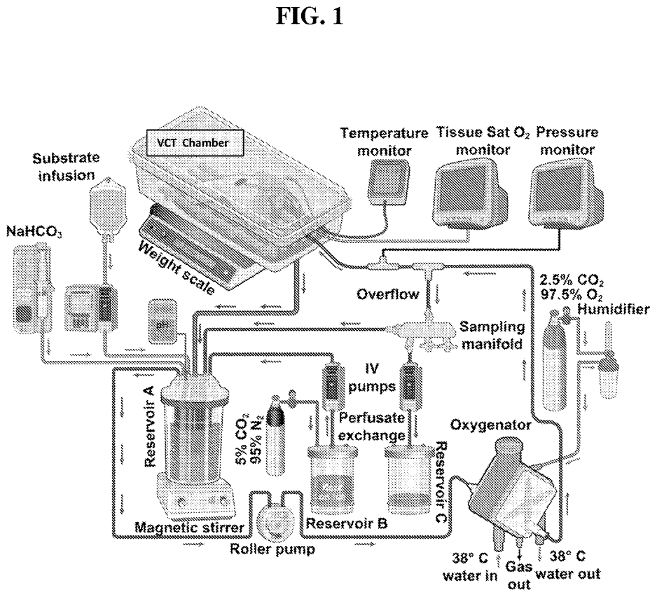

### DETAILED DESCRIPTION

Provided herein are perfusate compositions, and methods and systems for using such composition to perfuse a vascularized composite tissue (e.g., limb, face, abdominal wall, or flap) to preserve such composite tissues (e.g., for auto or allotransplant). In certain embodiments, the perfusate compositions comprise at least one of the following reagents: i) N-acetylcysteine; ii) pantothenate or pantothenic acid at a concentration of at least 15 micromol/liter in said composition; and/or iii) carnitine, as well as further comprising one of the following: i) at least one bicarbonate/CO₂-dependent anaplerotic substrate, and at least one bicarbonate/CO₂ buffer, or ii) at least one non-bicarbonate/CO₂-dependent anaplerotic substrate. In certain embodiments, the perfusate compositions are free, or detectably free, of alpha amino acids.

Ex vivo normothermic perfusion (EVNP) can extend the viability of human and porcine vascularized composite tissues (e.g., limbs) following amputation. However, the time the vascularized composite tissue can be preserved is not infinite and the muscle function gradually deteriorates, eventually leading to the end of perfusion. During the usual vascularized composite tissue procurement and transplantation process, the vascularized composite tissue is subject to ischemia which damages cell membranes and cellular organelles. Re-perfusion of the isolated vascularized composite tissue during EVNP with a blood substitute causes reperfusion injury that aggravates the ischemic damage to the cellular and mitochondrial membranes. Injury to mitochondrial membranes results in massive cataplerosis, i.e., the leakage of citric acid cycle (Krebs cycle) intermediates which carry acetyl groups, as they are oxidized to CO₂ to generate adenosine triphosphate (ATP). The physiological mechanisms which re-fill the pools of citric acid cycle intermediates (anaplerosis) are not sufficiently active during EVNP to restore physiological levels of citric acid cycle intermediates. The low rates of anaplerosis result from (i) the very low concentrations of pyruvate and propionyl-CoA precursors in the perfusate of re-perfused limbs, and (ii) the absence of bicarbonate/CO₂ in the perfusion buffer (bicarbonate/CO₂ is used in the carboxylation reactions catalyzed by pyruvate carboxylase and propionyl-CoA carboxylase).

The compositions and methods disclosed herein address these shortcomings. For example, adding anaplerotic substrates and bicarbonate/CO₂ to the perfusate will boost anaplerosis in muscle cells, restore the carbon flux through the citric acid cycle and increase ATP production. Anaplerotic substrates containing nitrogen atoms (e.g., amino acids aspartate, glutamate, glutamine, valine, isoleucine) are generally not suitable because their metabolism generates ammonia/ammonium which causes biochemical, molecular and organelle perturbations and is harmful to muscle cells. The main suitable anaplerotic processes therefore are pyruvate carboxylation and propionyl-CoA carboxylation. Via carboxylation (=CO₂ incorporation), pyruvate and propionyl-CoA are converted to citric acid cycle intermediates without generating toxic ammonia as would occur with amino acid substrates. Therefore, in some embodiments (e.g., to boost anaplerosis) the perfusate compositions herein may include: (i) a bicarbonate/CO₂ buffer, and (ii) one or more anaplerotic substrates (e.g., pyruvate, propionate, heptanoate, dodecanedioate, or another dicarboxylic acid which is a precursor of succinyl-CoA). While the present invention is not limited to any particular mechanism, and an understanding of the mechanism is not necessary to practice the invention, it is believed that the inclusion of anaplerotic substrate(s) in the perfusate of the isolated vascularized composite tissue restores the pools of citric acid cycle (Krebs cycle). In certain embodiments, the pH of the perfusate is maintained constant by an infusion of isotonic sodium bicarbonate delivered via a pH-stat apparatus that complements the beneficial effects of anaplerotic substrates by providing additional bicarbonate/CO₂ for generation of citric acid cycle intermediates oxaloacetate and succinyl-CoA. The electrolytic composition of the perfusate may be, in certain embodiments, maintained nearly constant by a low-rate continuous fractional replacement of the recirculating perfusate by fresh perfusate (e.g., 2-4%/hour). In some embodiments, the perfusate contains physiological concentrations of precursors of intra-cellular metabolites: pantothenate (a coenzyme A precursor for maintenance of oxidation of substrates in the citric acid cycle), and carnitine (to support the oxidation of endogenous fatty acids). In some embodiments, it also contains pharmacological concentration of N-acetylcysteine (e.g., up to about 1 mM, to preserve pools of —SH groups of enzymes and glutathione as antioxidants to protect again the ischemia reperfusion injury).

In certain embodiments, rapid clinical chemistry assays are used to assess the concentration of certain metabolites during EVNP, such as glucose, lactate, pyruvate, and ammonia acid-base parameters (e.g., pH, pO₂, pCO₂, bicarbonate, base excess, anion gap). These assays can be used, for example, (i) to modify and supplement the metabolites during perfusion to keep each of their concentrations in physiological range, and (ii) to make the final decision to transplant the vascularized composite tissue at the end of EVNP.

In certain embodiments, the perfusate compositions disclosed herein comprise one or more of the following:
(i) a bicarbonate/CO₂ buffer,
(ii) one or more anaplerotic substrates (pyruvate, propionate, heptanoate) restoring the pools of citric acid cycle (Krebs cycle),
(iii) an oxygen carrier (e.g., red blood cells, HBOC, etc.),
(iv) one or more energy substrate (e.g., glucose, fatty acids, amino acids, etc.);
(v) low concentrations of precursors of intra-cellular metabolites: A) pantothenate (a coenzyme A precursor for maintenance of oxidation of substrates in the citric acid cycle), B) N-acetylcysteine (to preserve pools of —SH groups of enzymes and glutathione as antioxidants to protect against the ischemia reperfusion injury), and C) carnitine (to support the oxidation of endogenous fatty acids).

In certain embodiments, the pH of the perfusate is maintained constant by an infusion of isotonic sodium bicarbonate delivered via a pH-stat apparatus, which, for example, complements the beneficial effects of anaplerotic substrates by providing bicarbonate/CO₂ for generation of citric acid cycle intermediate, oxaloacetate. In some embodiments, the electrolytic composition of the perfusate is maintained nearly constant by a continuous low-rate fractional replacement of the recirculating perfusate by fresh perfusate. In particular embodiments, rapid assays of the perfusate are conducted throughout the perfusion to assess (i) the near constancy of the perfusate composition, (ii) metabolic fluxes measured by balance and isotopic techniques, and (iii) any metabolic imbalance in the homeostatic parameters of the vascularized composite tissues.

In certain embodiments, the methods, perfusate solutions, and systems herein provide the necessary oxygen delivery, nutrients for metabolism, oncotic pressure, pH, perfusion pressures, temperature, and flow rates to support adequate vascularized composite tissue metabolism near the respective physiologic range. A near normal rate of metabolism is about 70-100% of normal rates of metabolism. In other embodiments, the methods, perfusate solutions, and systems herein support a level of metabolism during the period Ex vivo normothermic perfusion which supports sufficient oxidative metabolism to result in the normal functional product of the vascularized composite tissue once attached to the desired host (e.g., patient that is source of the vascularized composite tissue, or a non-autologous patient).

### EXAMPLE

### Example 1

### Perfusate Composition and Related Solutions

### Flush Solution

To be used for flushing the vascularized composite tissue after procurement from the donor and after ex vivo vascularized composite tissue preservation machine.

To prepare a 2 L solution
a. Dissolve the 3 chlorides (13.88 g NaCl+0.71 g KCl+0.76 g CaCl₂·2H₂O) in about 1.5 L of distilled water.
b. Gas the solution with pure CO₂ for 5 min
c. Dissolve MgSO₄·7H₂O (0.59 g), KH₂PO₄ (0.32 g), and NaHCO₃ (4.20 g) one at a time and gas with pure CO₂ between additions
d. Bring the volume to 2 L, gas for 10 min with pure CO₂.
e. Add 5 mM glucose (1.8 g) and 2 mM Na-pyruvate (440 mg) and gas with 95% O₂+5% CO₂ for 20 min.

### Perfusate Solution

For continuously perfusing the vascularized composite tissue in the ex vivo vascularized composite tissue preservation machine.

### Diluting Solution

a. Dissolve the 3 chlorides 7 g NaCl+0.35 g KCl+0.38 g CaCl₂·2H₂O in about 0.6 L of water
b. Gas the solution with pure CO₂ for 5 min
c. Dissolve MgSO₄·7H₂O (0.30 g), KH₂PO₄ (0.16 g), and NaHCO₃ (2.10 g) one at a time and gas 1 min with pure CO₂ between additions.
d. Bring the volume to 1 L and mix.

### Perfusate Solution (3 L)

f. Remove at 0.45 L diluting solution (from above) and add to the 3 L flask.
g. Add 0.65 L of albumin (13 bags, 250 mg/ml) to the flask.
h. Gently mix by shaking.
a. Add 2 L of heparinized red blood cells.
b. Additional components:
   i. Insulin: −0.1 unit
   ii. Methylprednisolone: 500 mg
   iii. Vancomycin: 500 mg
   iv. Cefazolin: 500 mg
   v. Ceftazimide: 500 mg
   vi. Dextrose: Add 5 cc of 25% dextrose
c. 5 ml of mixed solution (N-acetylcysteine (NAC)+pantothenate calcium+beta-alanine+choline+carnitine).
d. 0.3 mM Na pyruvate to the perfusate.
e. Additionally, mixed NAC solution is infused to the perfusate after the vascularized composite tissue connection at a rate of 5 ml/hr.

### Mixed Solution Containing 5 Substrates:

N-acetylcysteine (NAC)+pantothenate calcium+beta-alanine+choline+carnitine.
Recipe for preparing this five-substrate solution: in a 250 ml beaker, add sequentially:
1.575 g of N-acetylcysteine
322 mg of pantothenate calcium
176 mg of choline
1.06 g of carnitine
1.07 g of beta-alanine
   Dissolve with about 100 ml of water, adjust pH to 7 and bring total volume to 150 ml.

### REFERENCES

1. Duraes et al., Microsurgery. 2018;38(2):185-94.
2. Pozza et al., Limb Perfusion American Journal of Transplantation. 2017;17(3):305-6.
3. Fahradyan et al., Plast Reconstr Surg—Glob Open. 2018;6(8):56-7.
4. Russell, et al;, (1995), Am. J Physiol 268, H441-H447.
5. Russell, et al., (1991), J Clin Invest 87, 384-390.
6. Russell, et al., (1991), Am. J Physiol 261, H1756-H1762.
7. Taegtmeyer, et al., (1980), Biochem. J 186, 701-711.
8. Ruderman, et al., (1971), Biochem J 124, 639-651.
9. Jefferson, L. S. (1975), Methods Enzymol 39, 73-82.
10. Bunger et al., (1986), J Mol Cell Cardiol 18, 423-438.
11. Kristo et al., (2004), Am J Physiol Heart Circ Physiol 286, H517-524.
12. Mallet et al., (2018) Exp Biol Med (Maywood) 243, 198-210.
13. Mongan et al., (2001), Am J Physiol Heart Circ Physiol 281, H854-864
14. Roe et al., (2002), J Clin Invest 110, 259-269.
15. Roe et al., (2008), Neurology 71, 260-264.
16. Gu et al., (2009) Am. J Physiol Endocrinol. Metab. 2010 February;298(2):E362-71.
17. Roe, et al., (2015) Mol Genet Metab 116, 260-268
18. Vockley, et al., (2015), Mol Genet Metab 116, 53-60.
19. Gillingham et al., (2017), J Inherit Metab Dis 40, 831-843.
20. U.S. Pat. Pub. 20210338624
21. U.S. Pat. Pub. 2004/0038193
22. U.S. Pat. No. 5,599,659
23. U.S. Pat. No. 11,083,702
24. U.S. Pat. Pub. 20180318381
25. U.S. Pat. Pub. 20190038585
26. U.S. Pat. No. 10,071,070
27. U.S. Pat. Pub. 2021/0289771

All publications and patents mentioned in the specification and/or listed below are herein incorporated by reference. Various modifications and variations of the described method and system of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention that are obvious to those skilled in the relevant fields are intended to be within the scope described herein.

We claim:

1. A vascularized composite tissue perfusate composition comprising:
a) at least one of the following:
i) at least one bicarbonate/CO₂-dependent anaplerotic substrate, and at least one bicarbonate/CO₂ buffer, or
ii) at least one non-bicarbonate/CO₂-dependent anaplerotic substrate; and
b) wherein said composition is free or detectably free of alpha amino acids, and/or further comprises at least one of the following reagents:
i) N-acetylcysteine;
ii) pantothenate or pantothenic acid at a concentration of at least 15 micromol/liter in said composition; and/or
iii) carnitine.

2. The composition of claim 1, wherein said composition is free or detectably free of alpha amino acids.

3. The composition of claim 1, wherein said composition comprises N-acetylcysteine.

4. The composition of claim 3, wherein said N-acetylcysteine is present in said composition at a concentration of at least 50 micromol/liter, or at a concentration between 50 and 200 micromol/liter.

5. The composition of claim 1, wherein said composition comprises pantothenate or pantothenic acid at a concentration of at least 15 micromol/liter in said composition.

6. The composition of claim 5, wherein said pantothenate or pantothenic acid is present in said composition at a concentration between 15 and 50 micromol/liter.

7. The composition of claim 1, wherein said composition comprises carnitine.

8. The composition of claim 7, wherein said carnitine is present in said composition at a concentration of at least 50 micromol/liter, or at a concentration between 50 and 200 micromol/liter.

9. The composition of claim 1, wherein:
a) at least one bicarbonate/CO₂-dependent anaplerotic substrate is selected from the group consisting of: pyruvate, lactate, heptanoate, and precursors of propionyl-CoA; and/or
b) at least one non-bicarbonate/CO₂-dependent anaplerotic substrate is selected from the group consisting of: even-chain dicarboxylic acids, or their salts or esters, of at least 6 carbons length which are converted in tissues to succinyl-CoA.

10. The composition of claim 1, further comprising a blood substitute or packed red blood cells.

11. The composition of claim 1, wherein said at least one bicarbonate/CO₂ buffer comprises all of the following: sodium bicarbonate, magnesium sulphate, potassium phosphate, and NaCl+CaCl₂+KCl+glucose.

12. The composition of claim 1, further comprising at least one of the following: human albumin, insulin, glycerol, glucose, or methylprednisolone.

13. An ex vivo normothermic perfusion (EVNP) system for maintaining an isolated vascularized composite tissue in a near normal metabolic state comprising:
a) a perfusion subsystem comprising one or more perfusion fluid paths for circulating a perfusate composition; and
b) said perfusate composition, wherein said perfusate composition is as recited in claim 1.

14. The system of claim 13, further comprising: c) a vascularized composite tissue chamber configured for holding an isolated vascularized composite tissue, and wherein said perfusion subsystem is operably linked to said vascularized composite tissue chamber so as to perfuse a vascularized composite tissue when located in said vascularized composite tissue chamber.

15. The system of claim 14, wherein said vascularized composite tissue is selected from a limb, face, abdominal wall, or flap.

16. The system of claim 14, wherein said vascularized composite tissue comprises at least two of the following: skin, muscle, tendon, nerve, arteries, veins, and bone.

17. The system of claim 14, further comprising at least one of the following: an oxygen and carbon dioxide humidifier operably linked to said perfusion subsystem; a temperature controller for maintaining temperature of said perfusate composition at about 25-37 degrees Celsius; a monitoring subsystem for monitoring parameters of said perfusate composition; a tissue oxygen saturation and/or pressure monitoring subsystem; a pH monitoring and/or correcting subsystem operably linked to said perfusion subsystem; and an oxygenator operably linked to said perfusion subsystem.

18. A method of preserving an isolated vascularized composite tissue comprising:
placing an isolated vascularized composite tissue into a container, wherein said container has located within said perfusate composition as recited in claim 1.

19. The method of claim 18, wherein said container comprises a vascularized composite tissue chamber.

20. The method of claim 19, wherein said vascularized composite tissue chamber is operably linked to a perfusion subsystem that perfuses said vascularized composite tissue with said perfusate composition, wherein said perfusion subsystem comprises one or more perfusion fluid paths for circulating said perfusate composition.
